(19) United States
(12) Patent Application Publication
(10) Pub. No.: US 2023/0292035 A1
(43) Pub. Date: Sep. 14, 2023

(54) NOISE-ISOLATING HEADPHONE SYSTEMS FOR HEADGEGAR

(71) Applicant: HARMAN INTERNATIONAL INDUSTRIES, INCORPORATED, Stamford, CT (US)

(72) Inventors: Omid KHONSARIPOUR, Thousand Oaks, CA (US); Todd S. WELTI, Thousand Oaks, CA (US)

(21) Appl. No.: 18/246,831

(22) PCT Filed: Sep. 27, 2021
(86) PCT No.: PCT/US2021/052228

§ 371 Date: Mar. 27, 2023

Related U.S. Application Data
(60) Provisional application No. 63/084,428, filed on Sep. 28, 2020.

(51) Int. Cl. H04R 1/10; A42B 3/30

(52) U.S. Cl. CPC H04R 1/1083; H04R 1/1041; H04R 1/1008; H04R 1/1058; A42B 3/30

(57) ABSTRACT

A headphone system includes an audio output device, an ear pad coupled to a first side of the audio output device, and an inflatable pouch coupled to a second side of the audio output device. In some embodiments, the inflatable pouch inflates in at least a direction away from the second side of the audio output device.

### CROSS-REFERENCE TO RELATED APPLICATIONS

This application claims the priority benefit of United States provisional application titled, “NOISE-ISOLATING HEADPHONE SYSTEMS FOR HELMETS,” filed on Sep. 28, 2020, and having Ser. No. 63/084,428. The subject matter of this related application is hereby incorporated herein by reference.

### BACKGROUND

### Field of the Various Embodiments

The present disclosure is directed to headphones and, more particularly, to noise-isolating headphone systems for headgear.

### Description of the Related Art

Audio devices often include headphones that are positioned on a head of a user and that use an audio output device, such as a speaker, diaphragm, or the like, to generate sound based on an audio signal received from an audio source. In some audio devices, the audio source is integrated (e.g., an integrated audio player that generates the audio signal based on stored audio data). In some other audio devices, the audio source is external to the audio device, and the audio device receives the audio signal via a wired or wireless connection (e.g., a radio including an antenna that receives a wireless radio broadcast from a regional radio broadcasting station). In various audio devices, the headphones are permanently or detachably connected through a wired cable, or connected through a wireless communication channel (e.g., Bluetooth headphones).

Some headphones are designed to create a seal that serves as a sound barrier between the ears of the user and ambient noise. As an example, supra-aural headphones are designed to rest on the pinna of the ear. As another example, circumaural headphones are designed to surround or enclose the ear. In these and other designs, the headphones are configured to pass sound from the audio output device to the ear canal of the user while blocking or reducing ambient noise that would otherwise reach the ear of the user and interfere with the audio output. Some headphones are designed to create or maintain the seal by pressing inward against the ears or head when worn by the user.

In some scenarios, users wear headphones while also wearing headgear. As a first example, a user wears hard headgear, such as a helmet, for protection during an activity such as motorcycling, bicycling, playing a sport such as football or baseball, and/or the like. As a second example, a user wears soft headgear, such as a ski mask or balaclava, for warmth or protection from the elements during an activity such as skiing or snowboarding. In these and other scenarios, the headphones can output audio content for the enjoyment of the user during the activity, such as music, podcasts, radio programs, and/or the like. Alternatively or additionally, the headphones can output audio content that relates to the activity, such as directional audio cues from a navigation system, such as GPS, audio communication with other members of a team, and/or the like. Alternatively or additionally, the headphones can output active noise cancellation, such as anti-noise that destructively interferes with ambient noise of the environment of the user, which can reduce the noise perceived by the user.

However, headphones can exhibit some disadvantages when worn with headgear. The headgear can prevent manual contact by the user with the headphones, for example, to adjust a position of the headphones. If the headphones become displaced from a desired position on the head of the user (such as while donning or adjusting the headgear), the user could have difficulty repositioning the headphones without removing the headgear. Similarly, the headphones could interfere with donning or removing the headgear. Also, the space between the inner surface of the headgear and the head of the user can vary, for example due to differences in the size and shape of the headgear, the size and shape of the ears and head of the user, and/or the like. As a result, the comfort and fit of the headphones within particular headgear can vary for different users. Similarly, comfort and fit can vary for different headgear worn by a particular user. Further, asymmetry in the headgear and/or the head or ears of the user can create differences between the left and right headphone cups in terms of comfort or fit.

As another disadvantage, the seal created by some headphones can be reduced when worn with headgear. For example, headphones can create an acceptable seal while a user wears first headgear that presses the headphones against the head of the user but can create a less effective seal while the user wears second headgear that creates less pressure or no pressure. When one or both of the headphone cups do not consistently seal to the head and/or the ears of the user, a variable amount of audio signals can leak, leading to differences in the perceived low frequency response of the sound generator by different users and/or based on different placements of the headphones. As a result, significant roll-off below 500 Hz can occur in the perceived audio output of conventional headphone systems. Further, the incomplete seal reduces the isolation of audio output from ambient noise, which can interfere with the reception of the audio output by the user. Also, an incomplete seal can cause anti-noise generated by an active noise cancellation system to leak to the outside environment, reducing the effectiveness of noise cancellation. In some cases, asymmetry in the headgear and/or the head or ears of the user can create differences in the seal created by each of the left and right headphone cups.

As yet another disadvantage, contact between headphones and an inner surface of headgear can result in pressure, or friction such as rubbing (e.g., while the user dons, adjusts, or removes the headgear, and/or if the headgear shifts relative to the head of the user and the headphones). Such friction and rubbing can be uncomfortable for the user and/or can damage or mar the appearance of the headphones and/or the inner surface of the headgear. Friction can also produce noise that is irritating or distracting to the user.

As the foregoing illustrates, what is needed are noise-isolating headphone systems for headgear.

### SUMMARY

In some embodiments, a headphone system includes an audio output device, an ear pad coupled to a first side of the audio output device, and an inflatable pouch coupled to a second side of the audio output device.

In some embodiments, a headphone system includes an inflatable pouch, an audio output device coupled to a first side of the inflatable pouch, and an ear pad coupled to a second side of the inflatable pouch.

In some embodiments, an audio system includes an audio source and a headphone system including, an audio output device configured to generate output based on an audio signal received from the audio source, an ear pad, and an inflatable pouch coupled to the audio output device, wherein inflating the inflatable pouch while the headphone system is coupled to an inner surface of headgear causes the ear pad to press against at least one of a portion of a head of a user or a pinna of an ear of the user.

At least one technical advantage of the disclosed techniques relative to the prior art is that, with the disclosed techniques, an improved seal is created between the headphone cup and the ear of the user while wearing headgear. As a result, generated audio is less susceptible to leakage and more insulated from ambient noise, thus improving perceived audio quality. As another advantage, the disclosed techniques allow the headphone system to maintain a low profile while the headgear is being donned and/or removed so that interference of the headphone system with the donning and/or removing of the headgear is reduced. As yet another advantage, the disclosed techniques promote adaptability of the headphones for fit and comfort of different users and for use with different headgear. The disclosed techniques also provide adaptability for asymmetric shapes of the headgear and/or the head and ears of the user. As yet another advantage, the disclosed techniques reduce friction between other parts of the headphones and an inner surface of the headgear, which reduces noise and protects the headphones and the headgear from damage. These technical advantages provide one or more technological improvements over prior art headphones.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIGS. 1A-1B illustrate audio systems configured for use with one or more aspects of the various embodiments;

FIG. 2 is a front view of a first embodiment of one of the headphone cups of FIGS. 1A-1B, configured to implement one or more aspects of the various embodiments;

FIG. 3 is a front view of a second embodiment of one of the headphone cups of FIGS. 1A-1B, configured to implement one or more aspects of the various embodiments;

FIG. 4 is a front view of a third embodiment of one of the headphone cups of FIGS. 1A-1B, configured to implement one or more aspects of the various embodiments;

FIG. 5 is a side view of a circularly shaped inflatable pouch of the headphone system of FIG. 1A-1B, 2, or 3, according to various embodiments;

FIG. 6 is a side view of a ring-shaped inflatable pouch of the headphone system of FIG. 1A-1B, 2, 3, or 4, according to various embodiments;

FIG. 7 illustrates a flow diagram of method steps for a method of using the headphone system of FIG. 1A-1B, 2, 3, or 4 with headgear, according to various embodiments;

FIG. 8 illustrates a flow diagram of method steps for a method of removing the headphone system of FIG. 1A-1B, 2, 3, or 4 with headgear, according to various embodiments;

FIG. 9 illustrates a flow diagram of method steps for another method of using the headphone system of FIG. 1A-1B, 2, 3, or 4 with headgear, according to various embodiments; and

FIG. 10 illustrates a flow diagram of method steps for another method of removing the headphone system of FIG. 1A-1B, 2, 3, or 4 with headgear, according to various embodiments.

### DETAILED DESCRIPTION

In the following description, numerous specific details are set forth to provide a more thorough understanding of the various embodiments. However, the inventive concepts can be practiced without one or more of these specific details. In the figures, multiple instances of like objects are denoted with reference numbers identifying the object and parenthetical numbers identifying the instance where needed.

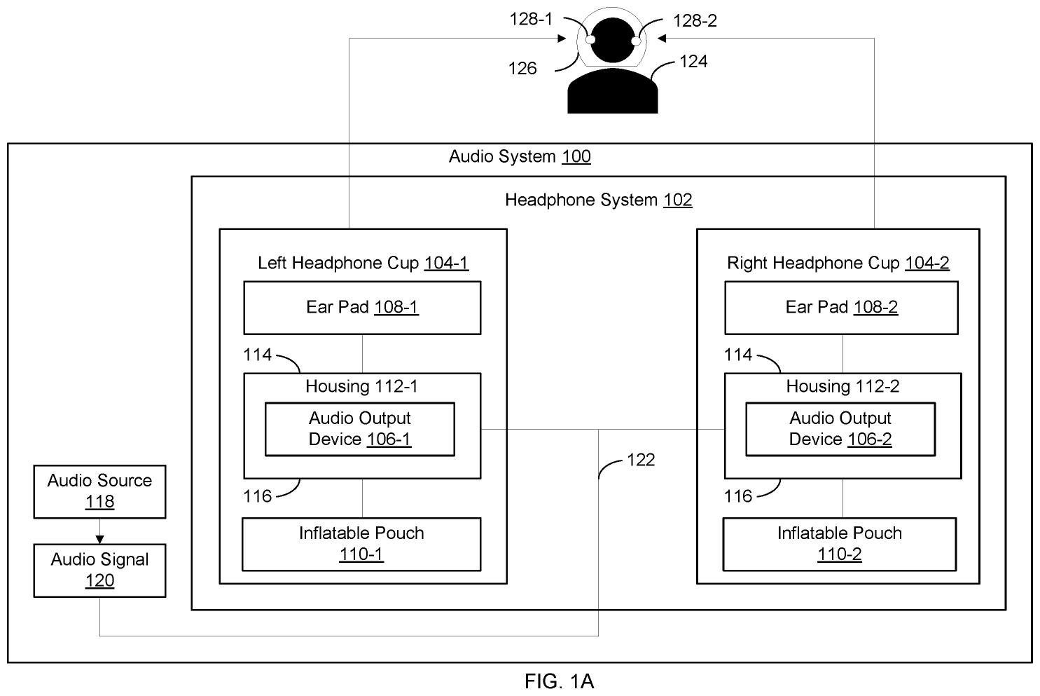

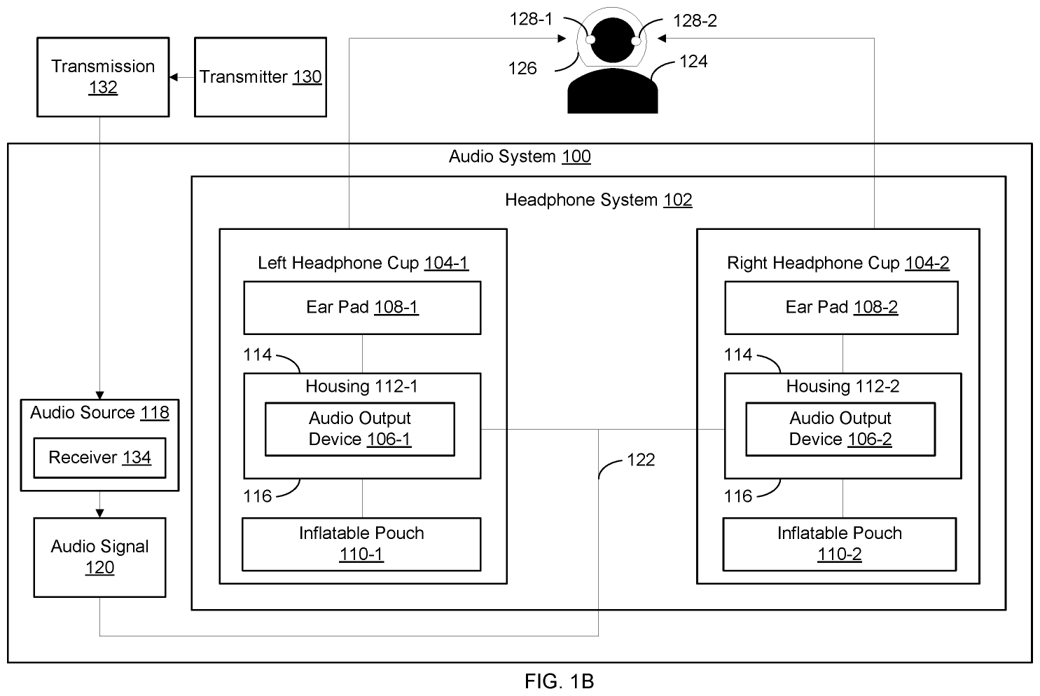

FIG. 1A illustrates an audio system 100 configured for use with one or more aspects of the various embodiments. The audio system 100 includes, without limitation, an audio source 118 and a headphone system 102 including a left headphone cup 104-1 and a right headphone cup 104-2. The audio system 100 can include any type of the headphone system 102 in which at least a portion of each headphone cup 104 of the headphone system 102 is designed to rest on and/or cover a corresponding ear 128 of a user 124 that is wearing the audio system 100.

As shown, the headphone system 102 includes, without limitation, a left headphone cup 104-1 and a right headphone cup 104-2. When the headphone system 102 is worn by a user 124, the left headphone cup 104-1 is positioned near a left ear 128-1 of the user 124, and the right headphone cup 104-2 is positioned near a right ear 128-2 of the user 124. In some embodiments, the headphone system 102 is a circumaural headphone, in which each headphone cup 104 is configured to surround an ear 128 of the user 124 and press against a portion of a head of the user 124. In some other embodiments, the headphone system 102 is a supraaural headphone, in which each headphone cup 104 is configured to press against a pinna of the ear 128 of the user 124.

As shown, each headphone cup 104-1, 104-2 includes a housing 112-1, 112-2, wherein each housing 112-1, 112-2 includes an audio output device 106-1, 106-2. The housing 112-1, 112-2 can be made of a rigid or firm material, such as a hard plastic, aluminum, or the like. Each housing 112-1, 112-2 can be of various shapes and/or sizes, such as (without limitation) circular, oval, rectangular, or the like. In various embodiments, each audio output device 106-1, 106-2 includes (for example, and without limitation) one or more speakers, diaphragms, piezoelectric transducers, or the like, as well as any number and/or combination thereof. The left audio output device 106-1 and the right audio output device 106-2 can include a same or similar type of audio output device, and/or can include different types of audio output devices. In some embodiments, each headphone cup 104-1, 104-2 is approximately 1.5 inches to 2.0 inches across.

As shown, each headphone cup 104-1, 104-2 includes a respective ear pad 108-1, 108-2 that is coupled to a first side 114 of the housing 112-1, 112-2 of the audio output device 106-1, 106-2 (e.g., an inward-facing side). In various embodiments, each ear pad 108-1, 108-2 is fixably or removably coupled to the housing 112-1, 112-2 using (for example and without limitation) a mechanical fastener such as a snap or button, an adhesive, a magnet, Velcro, or the like. Ear pad 108-1, 108-2 is designed to contact and/or surrounds an ear 128-1, 128-2 of the user 124 while the user 124 wears the headphone system 102. In some embodiments, each ear pad 108-1, 108-2 is made of a soft, elastic, and/or compressible material, such as rubber, cotton, neoprene, latex, a soft plastic, memory foam, or the like. In various embodiments, each ear pad 108-1, 108-2 has various shapes and/or sizes, such as (without limitation) circular, oval, rectangular, or the like. In some embodiments, in addition to the inflatable pouch 110-1, 110-2, at least one of the ear pads 108-1, 108-2 is inflatable.

Each headphone cup 104-1, 104-2 includes an inflatable pouch 110-1, 110-2, which is coupled to a second side 116 of the housing 112 of the audio output device 106-1, 106-2 (e.g., an outward-facing side). In some embodiments, a portion of the headphone system 102 (e.g., at least one of the inflatable pouches 110-1, 110-2, and/or at least one of the housing 112) is coupled to an inner surface of the headgear 126. In various embodiments, the headphone system 102 is affixed to the inner surface of the headgear 126 using (for example and without limitation) a mechanical fastener such as a snap or button, an adhesive, a magnet, Velcro, or the like. A user 124 can use the mechanical fastener to couple the headphone system 102 to an inner surface of headgear 126 before donning the headgear. Alternatively, a user 124 can don the headphone system 102 and then don the headgear 126, where contact between the mechanical fastener and the inner surface of the headgear 126 causes the headphone system 102 to couple to the inner surface of the headgear 126. In some embodiments, each inflatable pouch 110-1, 110-2 is coupled to the housing 112-1, 112-2 using (for example and without limitation) a mechanical fastener such as a snap or button, an adhesive, a magnet, Velcro, or the like.

In various embodiments, each inflatable pouch 110-1, 110-2 is made of a soft, elastic, flexible, impermeable, and/or compressible material, such as rubber, neoprene, latex, a soft plastic, plastic, memory foam, or the like. In various embodiments, each inflatable pouch 110-1, 110-2 is of various shapes and/or sizes, such as (without limitation) circular, oval, rectangular, or the like. In some embodiments, each inflatable pouch 110-1, 110-2 is configured to inflate in a direction away from the second side 116 of the audio output device 106-1, 106-2 (e.g., an outward direction). Alternatively or additionally, in some embodiments, each inflatable pouch 110-1, 110-2 is configured to inflate in a direction that is non-perpendicular to the second side 116 (e.g., a lateral or side direction).

Each inflatable pouch 110-1, 110-2 is at least partially inflatable by an inflation medium, such as air, a fluid such as water, or the like. In various embodiments, at least one of the inflatable pouches 110-1, 110-2 is inflatable by the breath of an individual such as the user 124, or an inflation mechanism such as an inflation bulb, a mechanical pump, an electrical pump, or the like. In some embodiments, at least one of the inflatable pouches 110-1, 110-2 includes a self-inflating and/or self-deflating mechanism. In some embodiments, each inflatable pouch 110-1, 110-2 includes at least one valve that permits passage of the inflation medium. In some embodiments, the valve permits passage of the inflation medium in an open configuration (e.g., for inflation and/or deflation) and prohibit passage of the inflation medium in a closed configuration (e.g., to retain the inflation and/or deflation). In some embodiments, the valve is a one-way valve that permits passage of the inflation medium in one direction and prohibits passage of the inflation medium in the opposite direction.

The user 124 can wear the headphone system 102 inside headgear 126, such as a helmet, a ski mask or balaclava, or the like. Inflating the inflatable pouch 110-1, 110-2 presses a side of the inflatable pouch 110-1, 110-2 against an inner surface of the headgear 126. The pressure further presses the headphone cup 104-1, 104-2 against the head or an ear 128-1, 128-2 of the user 124. The pressure of the headphone cup 104-1, 104-2 against the head or ear 128-1, 128-2 of the user 124 creates a seal between the headphone cup 104-1, 104-2 and the head or ear 128-1, 128-2 of the user 124, and/or retains a position of the headphone system 102 on the head of the user 124.

As shown, an audio source 118 originates an audio signal 120. The audio signal 120 is based on audio content, such as music, speech, noise, sound effects, or the like. In some embodiments, an active noise cancelling system generates anti-noise that destructively interferes with ambient noise. In some embodiments, the audio content is stored by the audio system 100 (e.g., by a data store configured to store recorded audio). Alternatively or additionally, in some embodiments, the audio content is generated by the audio system 100 and/or an external device. In some embodiments, the audio source 118 is an electronic device that is integrated with the audio system 100, such as an MP3 player, a smart phone, and/or the like. In some embodiments, audio signal 120 is a mono audio signal that is output by at least one of the audio output devices 106-1, 106-2. In some embodiments, the audio signal 120 includes stereo audio signal the includes a left audio signal that is output by the left audio output device 106-1 and a right audio signal that is output by the right audio output device 106-2. In some embodiments, the audio signal 120 encodes audio information in an analog encoding and/or digital encoding.

The audio source 118 transmits one or more audio signals 120 to one or both of the audio output devices 106-1, 106-2 via a signal wire 122. In some embodiments, the signal wire 122 includes a first signal wire 122 that transmits at least a portion of the audio signal 120 to the left audio output device 106-1, a second signal wire that transmits at least a portion of the audio signal 120 to the right audio output device 106-2 (e.g., another wire coupled to another audio output device 106), and one or more ground wires. In some embodiments, at least a portion of the signal wire 122 is integrated with the headphone system 102, such as a headband that is coupled to the left headphone cup 104-1 and the right headphone cup 104-2.

FIG. 1B illustrates another audio system configured for use with one or more aspects of the various embodiments. The audio system 100 includes, without limitation, an audio source 118 and a headphone system 102 including a left headphone cup 104-1 and a right headphone cup 104-2. In some embodiments, the audio system 100 includes any type of headphone system 102 in which at least a portion of each headphone cup 104-1, 104-2 is designed to rest on and/or cover a corresponding ear of a user that is wearing the audio system 100. In some embodiments, the headphone system 102 is a circumaural headphone, in which each headphone cup 104-1, 104-2 is configured to contact a portion of a head of the user 124. In some other embodiments, the headphone system 102 is a supraaural headphone, in which each headphone cup 104-1, 104-2 is configured to contact a portion of a pinna of an ear 128-1, 128-2 of a user 124. Elements of FIG. 1B can be or can include similar features as discussed with regard to the corresponding elements of FIG. 1A.

As shown, the headphone system 102 includes, without limitation, a left headphone cup 104-1 and a right headphone cup 104-2. When the headphone system 102 is worn by a user 124, the left headphone cup 104-1 is positioned near a left ear 118-1 of the user 124, and the right headphone cup 104-2 is positioned near a right ear 118-2 of the user 124.

As shown, the audio source 118 includes a receiver 134 that receives a transmission 132 from a transmitter 130. In some embodiments, the transmitter 130 includes a radio station that broadcasts a global, regional, or local AM or FM radio signal. In some embodiments, the transmitter 130 includes a wireless audio device that transmits a wireless audio signal, such as a Bluetooth audio signal. In some embodiments, the transmission 132 encodes audio information in an analog encoding and/or digital encoding. In some embodiments, the transmission 132 includes multiple channels, such as a stereo audio transmission. In some embodiments, the transmission 132 includes multiple audio streams, such as multiple radio stations. In some embodiments, the transmission 132 includes other data, such as video accompanying one or more audio streams, and/or metadata about the audio, such as text indicating song titles or lyrics. In some embodiments, the audio source 118 receives the transmission 132 by the receiver 134 and output an audio signal 120 for the audio output devices 106-1, 106-2. In some embodiments, the audio signal 120 is the same or similar to the transmission 132, or is a subset of the transmission 132, such as one radio station selected from multiple radio stations in the transmission 132. In some embodiments, the audio signal 120 encodes audio in the same or similar manner as the transmission 132. In some embodiments, the audio signal 120 is transcoded to a different encoding format (e.g., the transmission 132 is an analog encoding, and the audio signal 120 is a digital encoding). In some embodiments that include active noise cancelling, the transmitter 130 includes a microphone, the transmission 132 includes a sampling of ambient noise, and the audio source 118 generates the audio signal 120 that includes anti-noise that destructively interferes with the ambient noise.

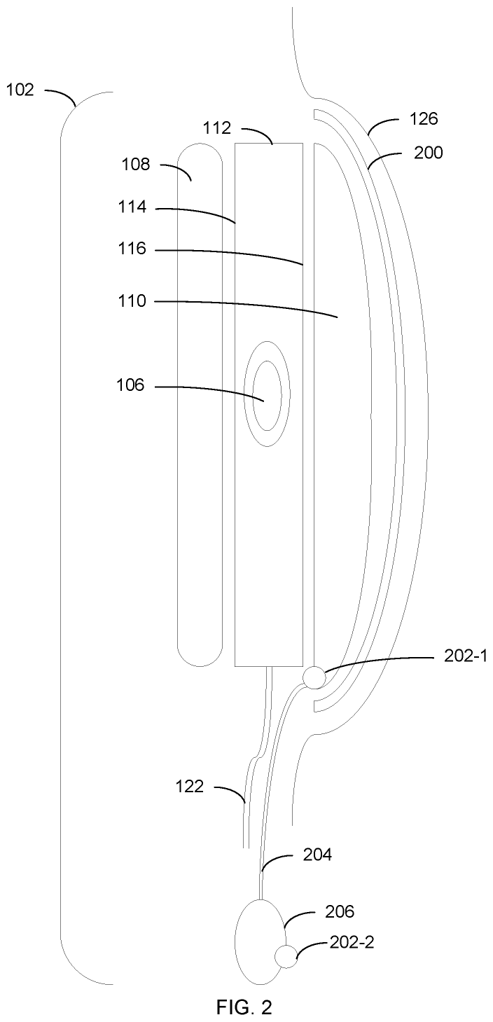

FIG. 2 is a front view of a first embodiment of one of the headphone cups 104 of FIGS. 1A-1B, configured to implement one or more aspects of the various embodiments. Although FIG. 2 shows the components of one headphone cup 104, it is to be appreciated that in some embodiments, the headphone system 102 includes a second headphone cup 104 with corresponding components. The headphone system 102 includes, without limitation, an ear pad 108, an audio output device 106, and an inflatable pouch 110. The headphone system 102 can be at least a portion of the headphone system of either FIG. 1A or 1B. The headphone system 102 is shown in use with headgear 126, such as a helmet, but the headgear 126 is not included in the headphone system 102 as shown.

As shown, the audio output device 106 is positioned between an ear pad 108 and an inflatable pouch 110. More specifically, the audio output device 106 includes a housing 112, the ear pad 108 is coupled to a first side 114 of the housing (e.g., an inward-facing side), and the inflatable pouch 110 is coupled to a second side of the housing 112 (e.g., an outward-facing side). In some embodiments, an outer surface of the inflatable pouch 110 is shaped to conform to an inner surface of headgear 126, such as a flat or curved shape. When at least partially inflated, the inflatable pouch 110 presses against an inner surface of the headgear 126. The pressure of the inflatable pouch 110 against the inner surface of headgear 126 also presses the housing 112 of the audio output device 106 and the ear pad 108 in a direction away from the inner surface of the headgear 126 and against a head or ear 128 of the user 124. The pressure of the ear pad 108 against the head or ear 128 of the user 124 creates a seal.

As shown, the inflatable pouch 110 includes a valve 202-1. In an open configuration, the valve 202-1 permits passage of an inflation medium, such as air, a fluid such as water, or the like. In a closed configuration, the valve 202-1 prohibits passage of the inflation medium in a closed configuration. In some embodiments, the inflatable pouch 110 includes one or more one-way valves that permit passage of the inflation medium in only one direction. In some embodiments, the inflatable pouch 110 includes a first one-way valve that, in an open configuration, permits passage of the inflation medium only into the inflatable pouch 110, and a second one-way valve that, in an open configuration, permits passage of the inflation medium only out of the inflatable pouch 110.

In some embodiments, the inflatable pouch 110 is inflatable by the breath of an individual, such as the user 124. Alternatively or additionally, in some embodiments, the inflatable pouch 110 includes an inflation mechanism that is configured to inflate and/or deflate the inflatable pouch 110. As shown, the inflation mechanism includes an inflation bulb 206 that is coupled to the valve 202-1. Manual compression of the inflation bulb 206 pushes an inflation medium, such as air, through the conduit 204 and the valve 202-1 and into the inflatable pouch 110, causing the inflatable pouch 110 to inflate. Manual release of the inflation bulb 206 causes the inflation bulb 206 to inflate (e.g., by receiving air through a one-way intake valve 202-2 on or integrated with the outer surface of the inflation bulb 206). Some embodiments include another type of inflation mechanism, such as a mechanical pump, an electrical pump, or the like. In some embodiments, the inflation mechanism is also configured to deflate the inflatable pouch 110. In some embodiments, the inflation bulb 206 includes an exhaust valve that, in an open configuration, permits an inflation medium such as air to be released from the inflatable pouch 110 and the inflation bulb 206, and, in a closed configuration, prohibits the inflation medium from being released from the inflatable pouch 110 and the inflation bulb 206.

In some embodiments and as shown, an inflation mechanism (such as the inflation bulb 206) is coupled to the valve 202-1 of the inflatable pouch 110 by a conduit 204, such as a flexible tube. In some other embodiments, the inflation mechanism is integrated with the inflatable pouch 110. In some embodiments, an inflation bulb 206 is integrated with an outer surface of the inflatable pouch 110 and coupled to the inflatable pouch 110 by a one-way valve 202.

As shown, the audio output device 106 includes a signal wire 122 configured to conduct an audio signal 120 from an audio source 118 to the audio output device 106. In some embodiments, the audio output device 106 includes a ground wire that conducts a return current from the audio output device 106, and/or provides a ground reference for the audio signal 120. In some embodiments, the signal wire 122 is coupled to the conduit 204 for the inflation mechanism, such as the inflation bulb 206. In some embodiments, the headphone system 102 includes a cable that conducts both the signal wire 122 and the conduit 204 for an inflation bulb 206, a mechanical pump, an electrical pump, or the like.

As previously mentioned, although FIG. 2 shows the components of only one headphone cup 104, it is to be appreciated that in some embodiments, the headphone system 102 includes a second headphone cup 104 with corresponding components. In some embodiments, a first inflation mechanism is coupled to the inflatable pouch 110 of a first headphone cup 104, and a second inflation mechanism is coupled to the inflatable pouch 110 of a second headphone cup 104. In some other embodiments, one inflation mechanism is coupled to the inflatable pouches 110 of both headphone cups 104, such as an inflation bulb or electrical pump that, when activated or manipulated, inflates both of the inflatable pouches 110. In some embodiments, an electrical pump is activated to inflate and/or deflate one or both of the inflatable pouches 110. In some embodiments, the electrical pump is activated by an activation mechanism included in the headphone system 102 (e.g., a button) and/or by a wireless signal (e.g., a Bluetooth signal). In some embodiments, one signal wire 122 is coupled to both audio output devices 106, while in some other embodiments, a first signal wire 122 is coupled to a first audio output device 106 and a second signal wire 122 is coupled to a second audio output device 106.

As shown, the headphone system 102 includes a mechanical coupler 200 configured to couple to an inner surface of the headgear 126. The mechanical coupler 200 is coupled to a surface of the inflatable pouch 110 (e.g., an outward-facing surface) and is configured to contact the inner surface of the headgear 126. In some embodiments, the mechanical coupler 200 includes a fastener such as a snap or button that couples to a portion of the inner surface of the headgear 126. In some embodiments, the mechanical coupler 200 includes a surface that affixes to an inner surface of the headgear 126 upon contact, such as Velcro, an adhesive, or a magnet. In some embodiments, the mechanical coupler 200 is reversible, so that each headphone cup 104 of the headphone system is coupled to the inner surface of the headgear 126 and also decoupled (e.g., removed) from the inner surface of the headgear 126. In some other embodiments, the mechanical coupler 200 is configured to affix, and to remain affixed, to the inner surface of the headgear 126.

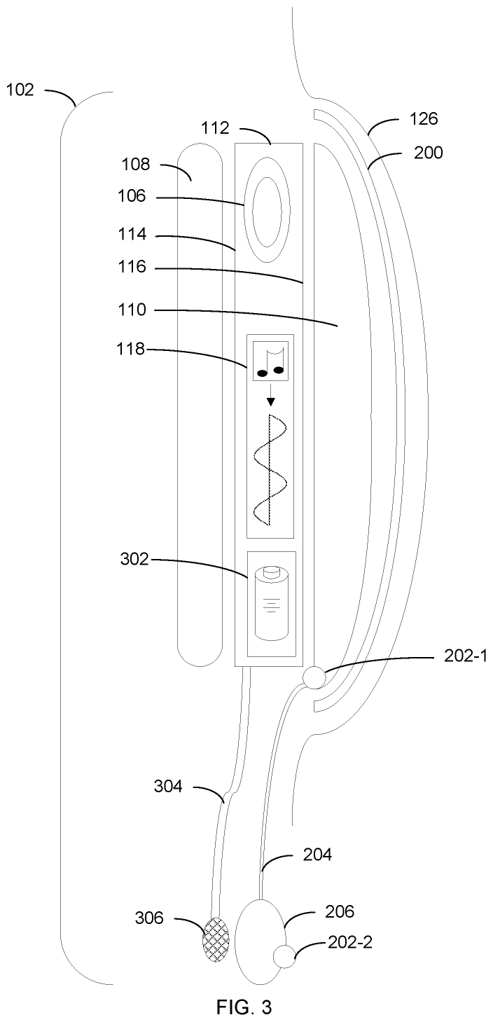

FIG. 3 is a front view of a second embodiment of one of the headphone cups 104 of FIGS. 1A-1B, configured to implement one or more aspects of the various embodiments. The headphone system 102 includes, without limitation, an audio output device 106, an ear pad 108, and an inflatable pouch 110. The headphone system 102 can be at least a portion of the headphone system of either FIG. 1A or 1B. The headphone system 102 is shown in use with headgear 126, such as a helmet, but the headgear 126 is not included in the headphone system 102 as shown. Although FIG. 3 shows the components of only one headphone cup 104, it is to be appreciated that in some embodiments, the headphone system 102 includes a second headphone cup 104 with corresponding components. Elements of FIG. 3 can be or can include similar features as discussed with regard to the corresponding elements of FIG. 2.

As shown, the audio output device 106 is positioned between an ear pad 108 and an inflatable pouch 110. More specifically, the audio output device 106 includes a housing 112, the ear pad 108 is coupled to a first side 114 of the housing (e.g., an inward-facing side), and the inflatable pouch 110 is coupled to a second side of the housing 112 (e.g., an outward-facing side). In some embodiments, an outer surface of the inflatable pouch 110 is shaped to conform to an inner surface of headgear 126, such as a flat or curved shape. When at least partially inflated, the inflatable pouch 110 presses against an inner surface of the headgear 126. The pressure of the inflatable pouch 110 against the inner surface of headgear 126 also presses the housing 112 of the audio output device 106 and the ear pad 108 in a direction away from the inner surface of the headgear 126 and against a head or ear 128 of the user 124. The pressure of the ear pad 108 against the head or ear 128 of the user 124 creates a seal.

As shown, the headphone system 102 includes an audio source 118. As previously discussed, in some embodiments, the audio source 118 includes an integrated audio player that generates the audio signal based on stored audio data and/or a receiver that receives a transmission from a transmitter. In some other embodiments, the audio source 118 is located elsewhere in the headphone system 102, such as a second headphone cup 104, or coupled with audio components at a remote end of the signal wire 122. In some embodiments, each headphone cup 104 includes an audio source 118, while in some other embodiments, one audio source 118 is coupled to the audio output devices 106 of both headphone cups 104.

The headphone system 102 further includes a power source 302 that is configured to store power. As shown, the power source 302 is included in the housing 112 of the audio output device 106. In some other embodiments, the power source 302 is located elsewhere in the headphone system 102, such as a second headphone cup 104, or coupled with audio components at a remote end of a signal wire 122. In some embodiments, the power source 302 is a battery, which is user-replaceable (e.g., via a user-accessible battery compartment) or user-rechargeable (e.g., via a charging port). In some embodiments, the power source 302 is coupled to the audio output device 106 and is configured to power the audio source 118. Alternatively or additionally, in some embodiments, the power source 302 is coupled to the audio output device 106 (e.g., a speaker) and is configured to power the audio output device 106 (e.g., to amplify the audio output). In some embodiments, each headphone cup 104 includes a power source 302, while in some other embodiments, one power source 302 is coupled to the audio sources 118 audio output device 106 and/or headphone cups 104.

As previously discussed, in some embodiments, the inflatable pouch 110 is coupled to an inflation mechanism, such as a mechanical pump, an electrical pump, or the like. In some embodiments, the inflation mechanism is coupled to the power source 302 and receives power from the power source 302 to inflate the inflatable pouch 110. In some other embodiments (not shown), the headphone system 102 includes a second power source that is coupled to an inflation mechanism, and the and the inflation mechanism receives power from the second power source 302 to inflate the inflatable pouch 110.

As shown, the headphone system 102 includes a microphone 306 that is coupled to the audio output device 106 by a signal wire 304 (including a ground wire). In some embodiments, the microphone 306 is remote, for example, affixed or affixable to an outer surface of the headgear 126. In some embodiments, the microphone 306 transmits an ambient audio signal to the audio output device 106. In some embodiments, the audio output device 106 includes the ambient audio signal in the audio output (e.g., an ambient pass-through system). Alternatively or additionally, in some embodiments, the audio output device 106 generates an antinoise signal based on the ambient audio signal. The antinoise signal can destructively interfere with the ambient audio to create noise cancellation.

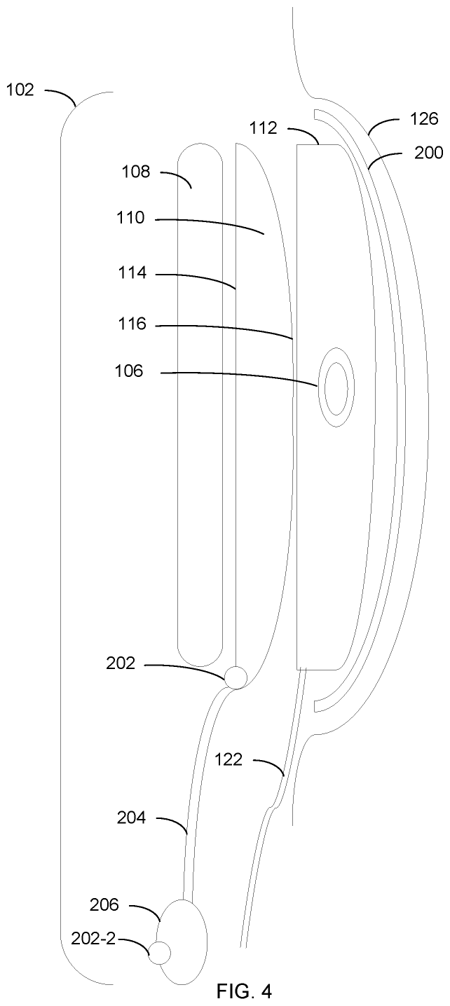

FIG. 4 is a front view of a third embodiment of one of the headphone cups 104 of FIGS. 1A-1B, configured to implement one or more aspects of the various embodiments. The headphone system 102 includes, without limitation, an audio output device 106, an ear pad 108, and an inflatable pouch 110. The headphone system 102 can be at least a portion of the headphone system of either FIG. 1A or 1B. The headphone system 102 is shown in use with headgear 126, such as a helmet, but the headgear 126 is not included in the headphone system 102 as shown. Although FIG. 4 shows the components of only one headphone cup 104, it is to be appreciated that in some embodiments, the headphone system 102 includes a second headphone cup 104 with corresponding components. Elements of FIG. 4 can be or can include similar features as discussed with regard to the corresponding elements of FIG. 2 or FIG. 3. Further, additional features discussed in relation to FIG. 2 and FIG. 3 (for example and without limitation, the housings 112 of the respective headphone cups 104, an audio source 118, and/or a power source 302) can be included in the third embodiment shown in FIG. 4.

As shown, and unlike FIGS. 2 and 3, the inflatable pouch 110 is located between the audio output device 106 and the ear pad 108 and the ear pad 108. More specifically, the ear pad 108 is coupled to a first side 114 of the inflatable pouch 110 (e.g., an inward-facing side), and the audio output device 106 includes a housing 112 that is coupled to a second side of the inflatable pouch 110 (e.g., an outward-facing side). In some embodiments, an outer surface of the housing 112 is shaped to conform to an inner surface of headgear 126, such as a flat or curved shape. When at least partially inflated, the inflatable pouch 110 presses the housing 112 against an inner surface of the headgear 126. The pressure of the housing 112 against the inner surface of headgear 126 also presses the ear pad 108 in a direction away from the inner surface of the headgear 126 and against a head or ear 128 of the user 124. The pressure of the ear pad 108 against the head or ear 128 of the user 124 creates a seal.

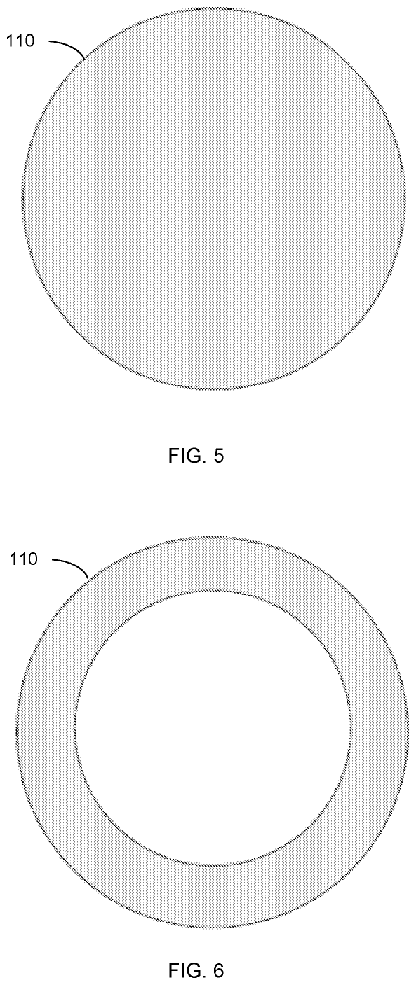

FIG. 5 is a side view of a circularly shaped inflatable pouch 110 of the headphone system 102 of FIG. 1A-1B, 2, or 3, according to various embodiments. As shown, the inflatable pouch 110 is formed to have a circular shape. In some embodiments, the inflatable pouch 110 can have substantially the same shape and/or size to a rear side of an audio output device 106. The circular shape causes the inflatable pouch 110, while inflated, to apply pressure between an inner surface of headgear 126 and at least most of a surface of a housing 112 of an audio output device 106. In turn, the housing 112 presses an ear pad 108 against a head or ear 128 of the user 124, which creates a seal.

FIG. 6 is a side view of a ring-shaped inflatable pouch 110 of the headphone system 102 of FIG. 1A-1B, 2, 3, or 4, according to various embodiments. As shown, the inflatable pouch 110 is formed to have a ring shape. In some embodiments, the outer portion of the ring-shaped inflatable pouch 110 can have substantially the same shape and/or size to a rear side of an audio output device 106. The ring shape causes the inflatable pouch 110, while inflated, to apply pressure between an inner surface of headgear 126 and at least an outer portion of a surface of a housing 112 of an audio output device 106. In turn, the housing 112 presses an ear pad 108 against a head or ear 128 of the user 124, which creates a seal. When used in the third embodiment shown in FIG. 4, the ring-shaped inflatable pouch 110 permits the audio output of the audio output device 106 of the headphone cup 104 to pass through to the ear of the user 124.

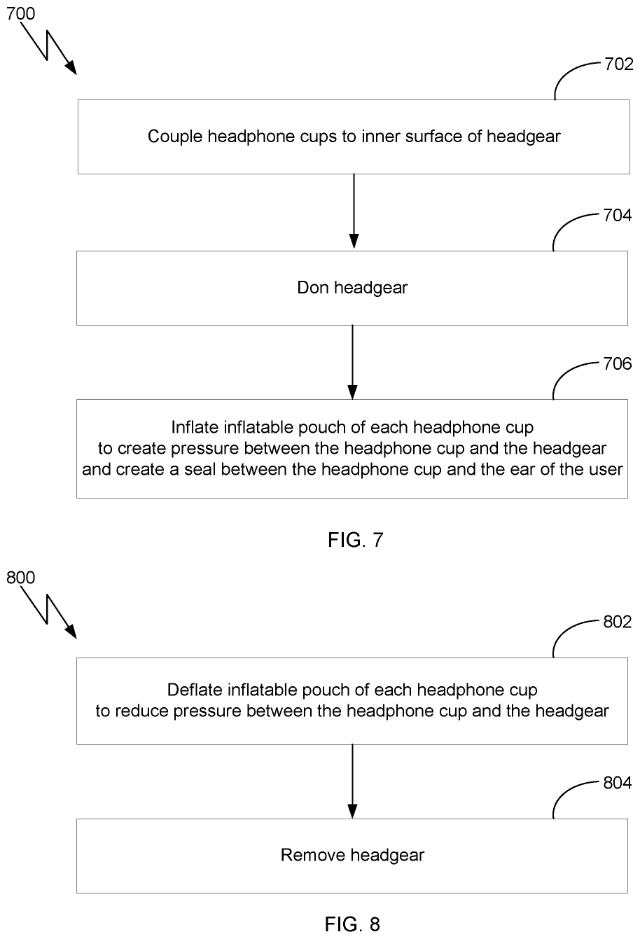

FIG. 7 illustrates a flow diagram of method steps for a method of using the headphone system of FIG. 1A-1B, 2, 3, or 4 with headgear, according to various embodiments. The method steps of FIG. 7 can be applied, e.g., by a user of the headphone system 102.

As shown, a method 700 begins at step 702 in which a user couples headphone cups of the headphone system to an inner surface of headgear. For example, the user can affix the headphone cups to an inner surface of a helmet by a mechanical fastener, such as a snap, or position the headphone cups on an inner surface of a balaclava by Velcro.

At step 704, the user dons the headgear. With the headphone system in a deflated state, the headphone system has a low profile, and the user can position the headgear at a comfortable position without the headphone system interfering significantly with the donning of the headgear. Due to the coupling of the headphone system to the inner surface of the headgear, the headphone system remains in place during such positioning.

At step 706, the user inflates an inflatable pouch of each headphone cup. In some embodiments, the user inflates the inflatable pouch using an inflation bulb, or by activating a mechanical or electrical pump to pump air into the inflatable pouch via a conduit. Inflating the inflatable pouch of each headphone cup creates pressure between the headphone cup and the headgear and creates a seal between the headphone cup and the ear of the user. The seal improves the audio quality and isolation of the output of the audio output device. Inflating the inflatable pouch of each headphone cup enables the shape of the inflatable pouch to conform to the shapes of the inner surface of the headgear and the head or ear of the user, which promote adaptability of the headphones for fit and comfort of different users and for use with different headgear. The pressure also improves retention of the headphone system at the desired position relative to the head of the user and the inner surface of the headgear. The audio output devices in the headphone system can then be used to provide audio to the user.

FIG. 8 illustrates a flow diagram of method steps for a method of removing the headphone system of FIG. 1A-1B, 2, 3, or 4 with headgear, according to various embodiments. The method steps of FIG. 8 can be applied, e.g., by a user of the headphone system 102.

As shown, a method 800 begins at step 802 in which a user deflates an inflatable pouch 110 of each headphone cup. In some embodiments, the user deflates the inflatable pouch by opening a valve on an inflation bulb, or by using a mechanical or electrical pump to evacuate air from the inflatable pouch. Deflating the inflatable pouches reduces pressure between the headphone cup and the headgear and reduces the profile of the headphone cup.

At step 804, the user removes the headgear. Because the headphone cups are coupled with the inner surface of the headgear, removing the headgear also removes the headphone cups from the head of the user. The user can turn off an audio source of the headphone system in order to conserve power. If the headphone system includes a rechargeable power source (e.g., a battery) for the audio source, the audio output device, and/or a mechanical or electric pump, the user can plug in the headphone system for next use.

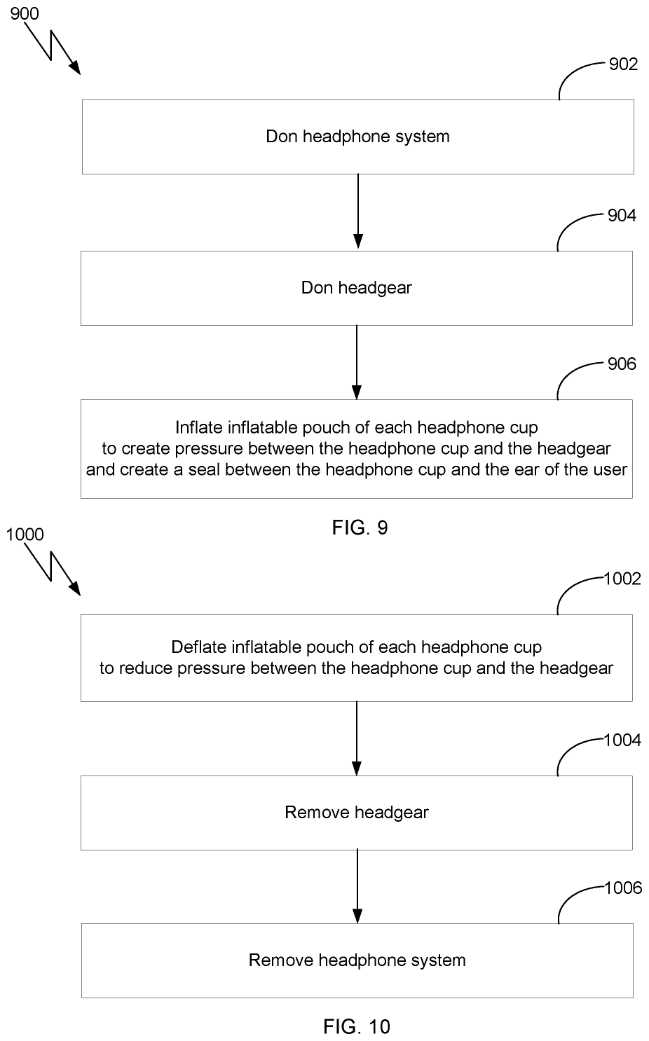

FIG. 9 illustrates a flow diagram of method steps for another method of using the headphone system of FIG. 1A-1B, 2, 3, or 4 with headgear, according to various embodiments. The method steps of FIG. 7 can be applied, e.g., by a user of the headphone system 102. Although the method steps of FIG. 7 are described with respect to the headphone system 102 of FIGS. 1A-B, many ways of using headphone systems including the method steps, in any order, can fall within the scope of the various embodiments.

As shown, a method 900 begins at step 902 in which a user dons the headphone system. The user can position each headphone cup at a comfortable position on or over the ear. The user can activate an audio source to cause the audio output device to output audio.

At step 904, the user dons the headgear. In some embodiments, an outer surface of the inflatable pouches and/or the housings includes a mechanical fastener (e.g., Velcro) that couples to the inner surface of the headgear upon contact. With the headphone system in a deflated state, the user can position the headgear at a comfortable position and/or adjust a position of the headphone system.

At step 906, the user inflates an inflatable pouch of each headphone cup to create pressure between the headphone cup and the headgear, and to create a seal between the headphone cup and the ear of the user. In some embodiments, the user inflates the inflatable pouch using an inflation bulb, or by activating a mechanical or electrical pump to pump air into the inflatable pouch via a conduit. Inflating the inflatable pouch of each headphone cup creates pressure between the headphone cup and the headgear and creates a seal between the headphone cup and the ear of the user. The seal improves the audio quality and isolation of the output of the audio output device. Inflating the inflatable pouch of each headphone cup enables the shape of the inflatable pouch to conform to the shapes of the inner surface of the headgear and the head or ear of the user, which promote adaptability of the headphones for fit and comfort of different users and for use with different headgear. The pressure also improves retention of the headphone system at the desired position relative to the head of the user and the inner surface of the headgear.

FIG. 10 illustrates a flow diagram of method steps for another method of removing the headphone system of FIG. 1A-1B, 2, 3, or 4 with headgear, according to various embodiments. The method steps of FIG. 10 can be applied, e.g., by a user of the headphone system.

As shown, a method 1000 begins at step 1002 in which a user deflates an inflatable pouch of each headphone cup to reduce pressure between the headphone cup and the headgear. In some embodiments, the user deflates the inflatable pouch by opening a valve on an inflation bulb, or by using a mechanical or electrical pump to evacuate air from the inflatable pouch. Deflating the inflatable pouches reduces pressure between the headphone cup and the headgear and reduces the profile of the headphone cup.

At step 1004, the user removes the headgear. If the headphone system is mechanically coupled to an inner surface of the headgear (e.g., via Velcro), the user can also uncouple the headphone system from the inner surface of the headgear.

At step 1006, the user removes the headphone system. The user can turn off an audio source of the headphone system in order to conserve power. If the headphone system includes a rechargeable power source (e.g., a battery) for the audio source, the audio output device, and/or a mechanical or electric pump, the user can plug in the headphone system for next use.

In sum, the disclosed headphone assembly includes an audio output device. In some embodiments, an ear pad is coupled to a first surface of the audio output device, and an inflatable pouch is coupled to a second surface of the audio output device. The inflatable pouches are deflated while the headgear is donned and/or removed. Inflating the inflatable pouches enables the headphone system to create an improved seal between the headphone cup and the ear of the user and adapts the shape of the headphone system to the shape of an inner surface of headgear worn by a user.

At least one technical advantage of the disclosed techniques relative to the prior art is that, with the disclosed techniques, an improved seal is created between the headphone cup and the ear of the user while wearing headgear. As a result, generated audio is less susceptible to leakage and more insulated from ambient noise, thus improving perceived audio quality. As another advantage, the inflatable pouches are deflated while the user dons or mounts the headgear, which maintains a low profile and enables the user to adjust the positions of the headphone system relative to the headgear and the head of the user. As yet another advantage, the inflatable pouches promote adaptability of the headphones for fit and comfort of different users and for use with different headgear. The inflatable pouches also provide adaptability for asymmetric shapes of the headgear and/or the head and ears of the user. As yet another advantage, the disclosed techniques reduce friction between other parts of the headphones and an inner surface of the headgear, which reduces noise and protects the headphones and the headgear from damage. These technical advantages provide one or more technological improvements over prior art headphones.

1. In some embodiments, a headphone system comprises an audio output device; an ear pad coupled to a first side of the audio output device; and an inflatable pouch coupled to a second side of the audio output device.

2. The headphone system of clause 1, wherein the audio output device includes a housing, the ear pad is coupled to a first surface of the housing, and the inflatable pouch is coupled to a second surface of the housing.

3. The headphone system of clauses 1 or 2, wherein the inflatable pouch inflates in at least a direction away from the second side of the audio output device.

4. The headphone system of any of clauses 1-3, wherein the inflatable pouch inflates in at least a direction that is non-perpendicular with the audio output device.

5. The headphone system of any of clauses 1-4, wherein the inflatable pouch includes at least one valve that permits passage of an inflation medium into the inflatable pouch.

6. The headphone system of any of clauses 1-5, further comprising an inflation mechanism configured to inflate the inflatable pouch.

7. The headphone system of any of clauses 1-6, further comprising a mechanical coupler configured to couple to an inner surface of headgear.

8. In some embodiments, a headphone system comprises an inflatable pouch; an audio output device coupled to a first side of the inflatable pouch; and an ear pad coupled to a second side of the inflatable pouch.

9. The headphone system of clause 8, wherein the audio output device includes a housing, and the inflatable pouch is coupled to a surface of the housing.

10. The headphone system of clauses 8 or 9, wherein the inflatable pouch includes at least one valve that permits passage of an inflation medium into the inflatable pouch.

11. The headphone system of any of clauses 8-10, further comprising an inflation mechanism configured to inflate the inflatable pouch.

12. The headphone system of clause 11, wherein the inflation mechanism includes at least one of an inflation bulb, a mechanical pump, or an electrical pump.

13. The headphone system of clauses 11 or 12, further comprising a conduit coupled to the inflatable pouch and the inflation mechanism.

14. The headphone system of any of clauses 8-13, further comprising a mechanical coupler configured to couple to an inner surface of headgear.

15. In some embodiments, an audio system comprises an audio source and a headphone system including, an audio output device configured to generate output based on an audio signal received from the audio source, an ear pad, and an inflatable pouch coupled to the audio output device, wherein inflating the inflatable pouch while the headphone system is coupled to an inner surface of headgear causes the ear pad to press against at least one of a portion of a head of a user or a pinna of an ear of the user.

16. The audio system of clause 15, wherein the ear pad is coupled to a first side of the audio output device, and the inflatable pouch is coupled to a second side of the audio output device.

17. The audio system of clauses 15 or 16, wherein the ear pad is coupled to a first side of the inflatable pouch, and the audio output device is coupled to a second side of the inflatable pouch.

18. The audio system of any of clauses 15-17, further comprising a signal wire configured to couple the audio output device to the audio source.

19. The audio system of any of clauses 15-18, wherein at least a portion of a signal wire is coupled to the audio output device and a conduit coupled to the inflatable pouch.

20. The audio system of any of clauses 15-19, further comprising a power source coupled to at least one of the audio output device or an inflation mechanism configured to inflate the inflatable pouch.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed.

Many modifications and variations will be apparent to those of ordinary skill in the art without departing from the scope and spirit of the described embodiments.

While the preceding is directed to embodiments of the present disclosure, other and further embodiments of the disclosure can be devised without departing from the basic scope thereof, and the scope thereof is determined by the claims that follow.

What is claimed is:

1. A headphone system, comprising:
an audio output device;
an ear pad coupled to a first side of the audio output device; and
an inflatable pouch coupled to a second side of the audio output device.

2. The headphone system of claim 1, wherein the audio output device includes a housing, the ear pad is coupled to a first surface of the housing, and the inflatable pouch is coupled to a second surface of the housing.

3. The headphone system of claim 1, wherein the inflatable pouch inflates in at least a direction away from the second side of the audio output device.

4. The headphone system of claim 1, wherein the inflatable pouch inflates in at least a direction that is non-perpendicular with the audio output device.

5. The headphone system of claim 1, wherein the inflatable pouch includes at least one valve that permits passage of an inflation medium into the inflatable pouch.

6. The headphone system of claim 1, further comprising an inflation mechanism configured to inflate the inflatable pouch.

7. The headphone system of claim 1, further comprising a mechanical coupler configured to couple to an inner surface of headgear.

8. A headphone system, comprising:
an inflatable pouch;
an audio output device coupled to a first side of the inflatable pouch; and
an ear pad coupled to a second side of the inflatable pouch.

9. The headphone system of claim 8, wherein the audio output device includes a housing, and the inflatable pouch is coupled to a surface of the housing.

10. The headphone system of claim 8, wherein the inflatable pouch includes at least one valve that permits passage of an inflation medium into the inflatable pouch.

11. The headphone system of claim 8, further comprising an inflation mechanism configured to inflate the inflatable pouch.

12. The headphone system of claim 11, wherein the inflation mechanism includes at least one of an inflation bulb, a mechanical pump, or an electrical pump.

13. The headphone system of claim 11, further comprising a conduit coupled to the inflatable pouch and the inflation mechanism.

14. The headphone system of claim 8, further comprising a mechanical coupler configured to couple to an inner surface of headgear.

15. An audio system, comprising:
an audio source; and
a headphone system including,
an audio output device configured to generate output based on an audio signal received from the audio source,
an ear pad, and
an inflatable pouch coupled to the audio output device,
wherein inflating the inflatable pouch while the headphone system is coupled to an inner surface of headgear causes the ear pad to press against at least one of a portion of a head of a user or a pinna of an ear of the user.

16. The audio system of claim 15, wherein the ear pad is coupled to a first side of the audio output device, and the inflatable pouch is coupled to a second side of the audio output device.

17. The audio system of claim 15, wherein the ear pad is coupled to a first side of the inflatable pouch, and the audio output device is coupled to a second side of the inflatable pouch.

18. The audio system of claim 15, further comprising a signal wire configured to couple the audio output device to the audio source.

19. The audio system of claim 15, wherein at least a portion of a signal wire is coupled to the audio output device and a conduit coupled to the inflatable pouch.

20. The audio system of claim 15, further comprising a power source coupled to at least one of the audio output device or an inflation mechanism configured to inflate the inflatable pouch.
